(19) United States
(12) Patent Application Publication
(10) Pub. No.: US 2006/0027218 A1
(43) Pub. Date: Feb. 9, 2006

(54) Positive crankcase ventilation valve

(76) Inventor: Arthur B. Cripps JR., Murray, KY (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/912,334

(22) Filed: Aug. 5, 2004

(51) Int. Cl. F02B 25/06

(52) U.S. Cl. 123/574

(57) ABSTRACT

A positive crankcase ventilation (PCV) valve having a housing and a valve and spring assembly. The housing may be constructed of an electrically conductive material and include an electrode integrated therein. The valve and spring assembly is disposed within the housing. The valve and spring assembly may be constructed of a metallic or a plastic material. The housing receives an electrical signal from a power source via the electrode. The electrical signal applied to the housing causes an increase in housing temperature thereby preventing freezing of the valve and spring assembly within the PCV valve.

### TECHNICAL FIELD

The present invention relates to a positive crankcase ventilation valve for an internal combustion engine, and in particular to a heated positive crankcase ventilation valve.

### BACKGROUND

A positive crankcase ventilation (PCV) system prevents unburned vapors from escaping an engine into the atmosphere. Known PCV systems include a valve (commonly referred to as a PCV valve) that typically has a spring, a plunger, and a hollow outer housing with an inlet and an outlet. The entire PCV valve intersects a tube that connects a crankcase to an intake manifold of the engine. The PCV valve reacts to changes in manifold vacuum pressure as it opens and closes the passageway that leads to the intake manifold. As the pressure increases in the manifold, the high vacuum overcomes the tension of the spring and causes the valve plunger to plug the opening within the valve, thereby reducing the flow of vapors. Under normal operating conditions the PCV valve is effective in reducing the amount of vapors escaping the engine. However, known PCV valves have been found to be less effective in cold environments, e.g. environments where the temperature is −55° C. or below. In cold environments, the presence of water within the system may cause the PCV valve to freeze. Accordingly, the PCV valve may be ineffective in preventing unburned vapors from escaping the engine.

In an effort to reduce the possibility of freezing of the PCV valve, one known approach is to heat the PCV valve by integrating a heating element into the valve housing. A method of carrying out this approach is the inclusion of a heating element having a heat sink with a resistance heating member disposed within the PCV valve. The heat sink is a thermally conductive metal cup that is directly exposed to the flow of crankcase gases. Alternatively, the heating element may consist of a single heat source, e.g., a PTC heater, without a heat sink attached thereto.

While, the above approach has been found effective, the addition of the heating element considerably increases cost and packaging considerations. For instance, the PCV valve housing must be designed to accommodate an additional heating element. Manufacturing costs increase as a result of having to manufacture the heating element. Furthermore, it is possible that the thermally conductive metal cup could become clogged or rusted, further reducing the effectiveness of the PCV system. Moreover, the addition of a component such as the heating element increases the amount of failure modes present in the PCV system. It would be desirable therefore to provide a PCV valve which reduces the complexity and cost of the known PCV valve systems while having the capability of operating in a cold environment.

### SUMMARY

The inventor of the present invention has recognized these and other problems associated with PCV systems in cold environments. To this end, the inventor has developed a PCV valve having a housing constructed of an electrically conductive material. The electrically conductive material may be comprised of a mineral and glass filled thermoset. The resins may be comprised of a vinyl ester, polyester, or phenolic base. In accordance with one aspect of the invention, the housing of the PCV valve has at least one electrode integrally molded therein. A spring and valve assembly is also included. The spring and valve assembly may be comprised of a metallic or plastic material. The plastic material may be acetel.

A method of making the inventive PCV valve is also disclosed, the method includes the step of forming a positive crankcase ventilation valve housing of an electrically conductive material. An additional step includes forming a valve and spring assembly. Yet another step includes installing the valve and spring assembly within the positive crankcase ventilation valve housing.

### BRIEF DESCRIPTION OF THE DRAWINGS

The accompanying drawings illustrate various embodiments of the present apparatus and method and are a part of the specification. The illustrated embodiments are merely examples of the present apparatus and method and do not limit the scope of the disclosure.

FIG. 1 is a perspective view of a positive crankcase ventilation valve including at least one electrode and a valve and spring assembly, according to an embodiment of the present invention.

FIG. 2 is a perspective view of a bottom portion of a positive crankcase ventilation valve including at least one electrode, according to an embodiment of the present invention.

FIG. 3 is a perspective view of a pair of electrodes according to an embodiment of the present invention.

FIG. 4A is a cross-sectional drawing of a valve and spring assembly for a positive crankcase ventilation valve according to an embodiment of the present invention.

FIG. 4B is a perspective view of the valve and spring assembly of FIG. 4A

FIG. 5 is a flow chart illustrating a method of making a positive crankcase valve according to an embodiment of the present invention.

### DESCRIPTION OF THE EMBODIMENT(S)

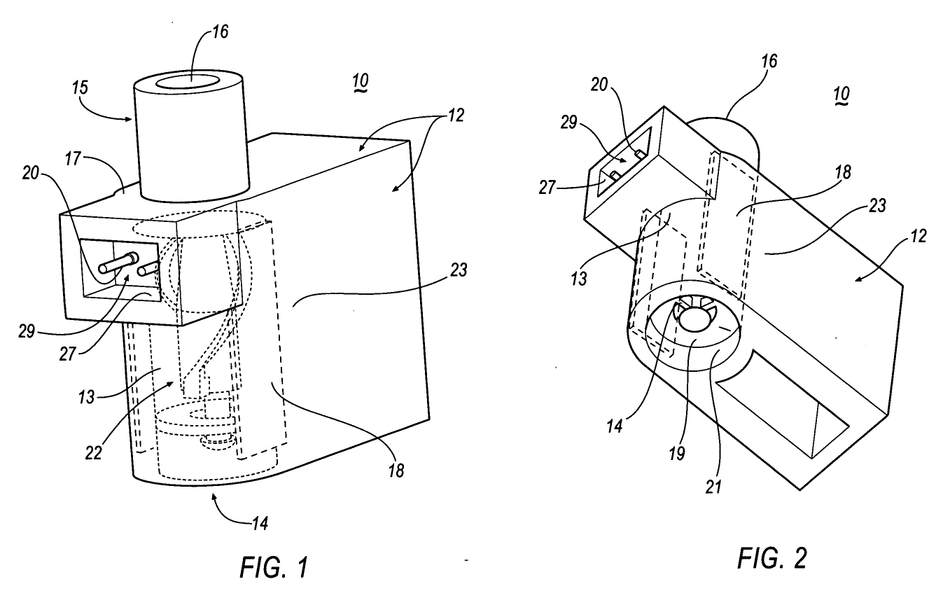

Referring now to FIGS. 1 and 2, an illustration of a positive crankcase ventilation (PCV) valve 10 is provided. The PCV valve 10, as recognized by one skilled in the art, prevents unburned vapors from escaping an engine crankcase (not shown) of a vehicle. Accordingly, the PCV valve 10 prevents the emission of “blow-by” gases from the engine crankcase into the atmosphere. Typically, the PCV valve 10 is mounted between the engine crankcase and an intake manifold (not shown) within the engine compartment of the vehicle.

The PCV valve 10 includes an enclosed housing 12 that defines a hollow chamber 13 therein. The housing 12 further includes sidewalls 23, extending walls 27 that define a chamber 29, an inlet 14, an outlet 16, at least one electrode 18 integrated therein, and a valve and spring assembly 22. The housing 12 may optionally be integrated into a cam cover (not shown) of the engine.

The inlet 14 is operatively connected to the hollow chamber 13 and forms an aperture through which “blow-by” gases enter the hollow chamber 13 of the PCV valve 10 from the engine crankcase (not shown). In one embodiment, inlet 14 is positioned in a downwardly opening cup portion 19 that is defined by a downwardly extending wall 21 (as seen in FIG. 2). The outlet 16 is defined by a tubular casing 15 that extends upwardly from a top surface 17 of the housing 12. The outlet 16 forms an aperture through which “blow-by” gases exit the PCV valve 10 into the intake manifold (not shown).

The housing 12 may be constructed of an electrically conductive material. In one embodiment, the electrically conductive material is a mineral and glass filled thermoset. More specifically, the mineral and glass filled thermoset may be comprised of a vinyl ester base, a polyester base, or a phenolic base. The housing 12 is preferably constructed as a unitary member.

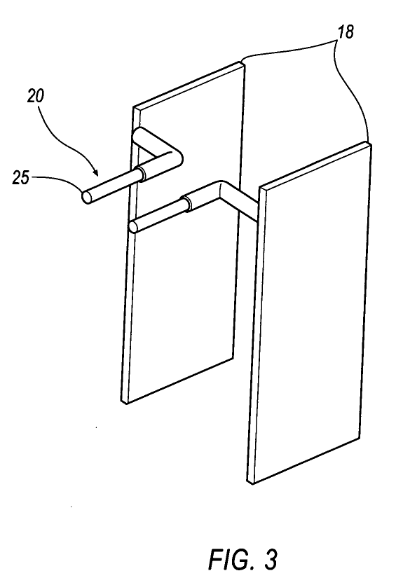

Referring to FIG. 3, the electrode 18 and an electrode contact 20 are illustrated. The electrode 18 is integrated into sidewalls 23 of the housing 12 in an area adjacent to the hollow chamber 13 of the housing 12. In accordance with one aspect of the invention, the electrode 18 is molded into the housing 12 with the electrode contact 20 having a distal end 25 that is connected to the electrode 18. The distal end 25 extends outwardly from the interior of the housing 12. The distal end 25 of the electrode contact 20 may be protected by outwardly extending walls 27 that define the chamber 29 for the electrode contact 20 (as seen in FIG. 1).

In accordance with one aspect of the invention, the electrode 18 enables heating of the PCV valve 10 by an application of electric current via the electrode contact 20. The source of the electric current may be a vehicle battery (not shown) or any other suitable power supply well known in the art. The power supply typically includes a female connection that receives the distal end 25 of the electrode contact 20. The electrode 18 and the electrode contact 20 are also comprised of an electrically conductive material that generates heat when energized by electric current. Heating the PCV valve 10 ensures proper and efficient functioning of the PCV valve 10 in colder temperatures (e.g., −55° C.) as will be discussed in more detail below. The electrode 18 as illustrated has a substantially rectangular shape. However, the electrode 18 may be any shape or configuration that is suitable for the particular vehicle application.

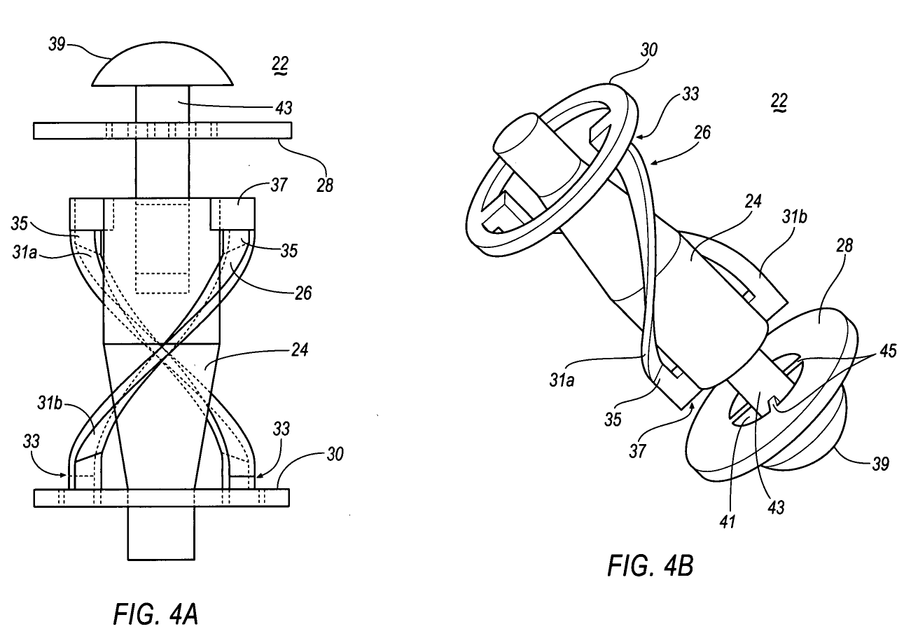

Referring to FIGS. 4A and 4B, a cross-sectional drawing and a perspective view of the valve and spring assembly 22 is illustrated. Preferably, the valve and spring assembly 22 is disposed within the hollow chamber 13 of the housing 12. The valve and spring assembly 22 is comprised of a valve plunger 24, a spring 26, a washer 28, and a spring support 30.

In one embodiment, spring 26 includes a pair of spring arms 31a, 31b. Each spring arm 31a, 31b includes a first end 33 and a second end 35. First end 33 is connected to spring support 30. Second end 35 is connected to a bottom portion 37 of valve plunger 24. Spring arms 31a, 31b are preferably spiraled around valve plunger 24.

The washer 28 includes a central opening 41 that encircles a plunger arm 43 that extends from the bottom portion 37 of valve plunger 24. To insure that washer 28 is centered around plunger arm 43, a plurality of locating fingers 45 extend inwardly from the periphery of central opening 41.

As shown, the valve and spring assembly 22 may be a one-piece unit. As such, the valve plunger 24 is integrated with the spring 26. Furthermore, the spring 26 is also integrated with the spring support 30. The washer 28 cooperates with a sealing element 39 to enable sealing of the outlet 16 and locating the valve and spring assembly 22 within the housing 12 (as seen in FIGS. 1 and 2).

The valve and spring assembly 22 reacts to changes in manifold pressure. As the manifold pressure increases and surpasses a predetermined pressure threshold, the pressure forces the spring 26 to compress, causing the valve plunger 24 to “un-plug” the inlet 14 of the housing 12. As such, the un-plugged inlet 14 allows the passage of gases through the PCV valve 10.

In one embodiment, the valve and spring assembly may be comprised of a metallic material such as iron, steel, aluminum, or any other suitable metallic material. As discussed above, in colder temperatures the conventional PCV valve has a tendency to freeze, rendering the valve and spring assembly 22 non-responsive to changes in manifold pressure. According to an embodiment of present invention, application of an electric current to the integrated electrode 18 results in heating of the housing 12. Accordingly, by way of heat conduction from the housing 12, the temperature of the valve and spring assembly 22 increases. The increased temperature of the valve and spring assembly 22 prevents freezing of the valve and spring assembly 22 in colder temperatures. In another embodiment, the valve and spring assembly 22 may be comprised of a plastic material. As such, the valve and spring assembly 22 may be molded out of a plastic material such as acetel or any other suitable non-metallic material. Forming the valve and spring assembly 22 out of a non-metallic material such as acetel further reduces the probability of freezing. Because of the intrinsic characteristics of acetel, frozen vapor is less likely to form on the valve and spring assembly 22.

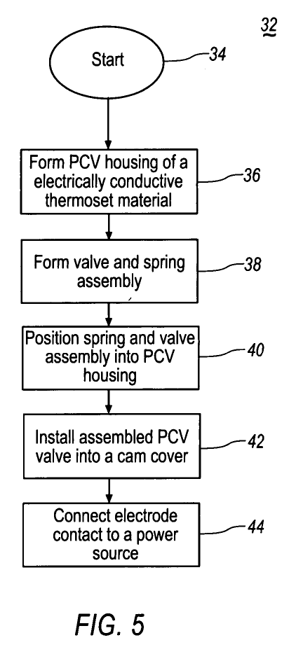

Referring now to FIG. 5, a flow chart illustrates a method 32 for manufacturing the PCV valve 10 according to an embodiment of the present invention. Accordingly, a step 34 is the entry step for the method 32. At step 36, the PCV valve housing 12 is formed having the hollow chamber 13. The PCV valve housing 12 may be formed by injection molding or any other known technique. Next, the electrode 18 and electrode contact 20 are integrated within the housing 12 (step 36). The housing 12 may be molded out of a non-metallic material such as plastic. The plastic material may be acetel. Additionally, the housing 12 may be formed of a mineral and glass filled thermoset. Furthermore, the housing 12 may be molded by a conventional plastic molding tool well-known in the art. At step 38, the valve and spring assembly 22 is formed. As discussed above, the valve and spring assembly 22 may be constructed of a metallic or non-metallic material. At step 40, the valve and spring assembly 22 is positioned within the hollow chamber 13 of the PCV housing 12. At step 42, the PCV valve 10 is installed into a cam cover (not shown) of the engine. Installation of the PCV valve 10 into the cam cover is accomplished in a manner well-known in the art. At step 44, the electrode contact of the PCV valve is connected to a power source.

It should be understood that the aforementioned and other various alternatives to the embodiments of the invention described herein may be employed in practicing the invention. It is intended that the following claims define the scope of the invention and that the method and apparatus within the scope of these claims and their equivalents be covered thereby.

What is claimed is:

1. A positive crankcase ventilation valve comprising:
a housing constructed of an electrically conductive material and having at least one electrode integrated therein and
a valve and spring assembly disposed within said housing.

2. A positive crankcase ventilation valve according to claim 1, wherein said electrically conductive material is a mineral and glass filled thermoset.

3. A positive crankcase ventilation valve according to claim 2, wherein said mineral and glass filled thermoset is comprised of a vinyl ester base.

4. A positive crankcase ventilation valve according to claim 2, wherein said mineral and glass filled thermoset is comprised of a polyester base.

5. A positive crankcase ventilation valve according to claim 2, wherein said mineral and glass filled thermoset is comprised of a phenolic base.

6. A positive crankcase ventilation valve according to claim 1, wherein the housing includes a chamber for protecting said at least one electrode.

7. A positive crankcase ventilation valve according to claim 1, wherein said housing has a pair of electrodes integrated therein on opposite sides of said housing.

8. A positive crankcase ventilation valve according to claim 1, wherein said valve and spring assembly comprises:
at least one spring arm having a first and a second end;
a spring support connected to the first end of said spring arm; and
a valve plunger having a first end with a bottom portion and a second end, wherein the first end of said valve plunger is connected to the second end of said spring arm and the second end of said valve plunger extends outwardly towards said spring support.

9. A positive crankcase ventilation valve according to claim 8, wherein said valve and spring assembly further comprises:
a washer having a central opening with locating fingers that extend inwardly from the periphery of the central opening;
a plunger arm having a first end and a second end that intersects the central opening of said washer and is centered within the central opening by the locating fingers of said washer, wherein the first end of said plunger arm is connected to the bottom portion of the first end of said valve plunger; and
a sealing element connected to the second end of said plunger arm.

10. A positive crankcase ventilation valve according to claim 8, wherein said spring arms are spirally positioned around said valve plunger.

11. A positive crankcase ventilation valve according to claim 1, wherein said valve and spring assembly is constructed of a metallic material.

12. A positive crankcase ventilation valve according to claim 1, wherein said valve and spring assembly is constructed of a non-metallic material.

13. A positive crankcase ventilation valve according to claim 12, wherein said non-metallic material is acetel.

14. A positive crankcase ventilation valve comprising:
a housing constructed of an electrically resistant thermoset plastic having at least two integrated electrodes, wherein said electrodes are positioned adjacent to a hollow chamber of said housing;
a one-piece valve and spring assembly having a washer attached thereto, said valve and spring assembly disposed within said hollow chamber of said housing.

15. A positive crankcase ventilation valve according to claim 14, wherein the thermoset plastic is a mineral and glass filled thermoset having a vinyl ester base.

16. A positive crankcase ventilation valve according to claim 14, wherein the thermoset plastic is a mineral and glass filled thermoset having a polyester base.

17. A positive crankcase ventilation valve according to claim 14, wherein the thermoset plastic is a mineral and glass filled thermoset having a phenolic base.

18. A positive crankcase ventilation valve according to claim 14, wherein the one-piece valve and spring assembly is construct of a metallic material.

19. A positive crankcase ventilation valve according to claim 14, wherein the one-piece valve and spring assembly is constructed of a plastic material.

20. A positive crankcase ventilation valve according to claim 14, wherein said plastic material is acetal.
